(19) United States
(12) Patent Application Publication
(10) Pub. No.: US 2014/0130918 A1
(43) Pub. Date: May 15, 2014

(54) Air Compressor

(71) Applicant: ACTIVE TOOLS INTERNATIONAL (HK) LTD., Causeway Bay (HK)

(72) Inventor: David Ying Chi Hong, Causeway Bay (HK)

(73) Assignee: ACTIVE TOOLS INTERNATIONAL (HK) LTD., Causeway Bay (HK)

(21) Appl. No.: 13/674,375

(22) Filed: Nov. 12, 2012

(51) Int. Cl. F17D 1/00

(52) U.S. Cl. CPC F17D 1/00
USPC 137/798

(57) ABSTRACT

The present invention discloses an air compressor, comprising a sealant bottle (1), a bottle cap (2) connected with the sealant bottle (1), a flexible pipe (4) and a housing (5). Its characteristics are in that, the flexible pipe (4) is connected with the bottle cap (2) through a quick connector (3), and the bottle cap (2) is fixed on the housing (5). The advantageous effect when implementing the present invention is as follows: in the air compressor, the connecting structure between its flexible pipe and its sealant bottle is simple in structure, convenient in operation and low in cost.

### FIELD OF THE INVENTION

The present invention relates to the field of air compressor, more particularly, to an air compressor using a quick connector.

### BACKGROUND OF THE INVENTION

Air compressor is the main component of a gas source device. It can convert the mechanical energy of a primer motor (which usually refers to a electric motor) to the gas pressure energy, and it is the gas pressure generating device for compressed air. There are many kinds of air compressors, which can be divided into displacement compressor and velocity compressor according to working principle. The working principle of the displacement compressor is to compress the volume of the gas, so that the density of the gas molecules in the unit volume can increase in order to improve the pressure of the compressed air; the working principle of the velocity compressor is to improve the movement speed of the gas molecules, so that the kinetic energy of the gas molecules is turned into the pressure energy of the gas in order to improve the pressure of the compressed air. In general, the flexible pipe connected with the sealant bottle of the air compressor is located inside the air compressor, wherein it is connected with the sealant bottle by a threaded connector. In this case, there is a danger of cross threading, and the assembly time and assembly cost are relatively high.

### SUMMARY OF THE INVENTION

The objective of the present invention is to provide an air compressor using a quick connector, aiming at the above-mentioned drawbacks that high assembly time and assembly cost are required for connecting the flexible pipe with the sealant bottle of the air compressor in the prior art.

The technical solution of the present invention for solving the technical problem is to construct an air compressor. The air compressor comprises a sealant bottle, a bottle cap connected with the sealant bottle, a flexible pipe and a housing. Its characteristics are in that, the flexible pipe is connected with the bottle cap through a quick connector and the bottle cap is fixed on the housing.

In the air compressor of the present invention, the bottle cap comprises a concave connecting section connected with the sealant bottle, a convex connecting section connected with the quick connector, a groove, a retaining pin and a base. The retaining pin comprises a guide part and a lowering plat part.

In the air compressor of the present invention, the quick connector comprises a concave connecting member, a slot located in the concave connecting member and a convex connecting member. The slot comprises a slotted hole connected with the guide part correspondingly. Through the connection with the retaining pin, the connection between the quick connector and the bottle cap is ensured to be locking.

The advantageous effect when implementing the present invention is as follows: in the air compressor, the connecting structure between the flexible pipe and the sealant bottle is simple in structure, convenient in operation and low in cost.

### BRIEF DESCRIPTION OF THE DRAWINGS

The present invention will be further described with reference to the accompanying drawings and embodiments in the following. In the Figures:

FIG. 1 is a diagram illustrating the stereostructure of the air compressor in the present invention;

FIG. 2 is a diagram illustrating the stereostructure of the quick connector;

FIG. 3 is a stereogram illustrating the connection between the quick connector and the flexible pipe;

FIG. 4 is a front view of the bottle cap; and

FIG. 5 is a stereogram illustrating the connection between the sealant bottle and the bottle cap.

### DETAILED DESCRIPTION OF THE PREFERRED EMBODIMENT

To make the technical feature, objective and effect of the present invention be understood more clearly, now the specific implementation of the present invention is described in detail with reference to the accompanying drawings.

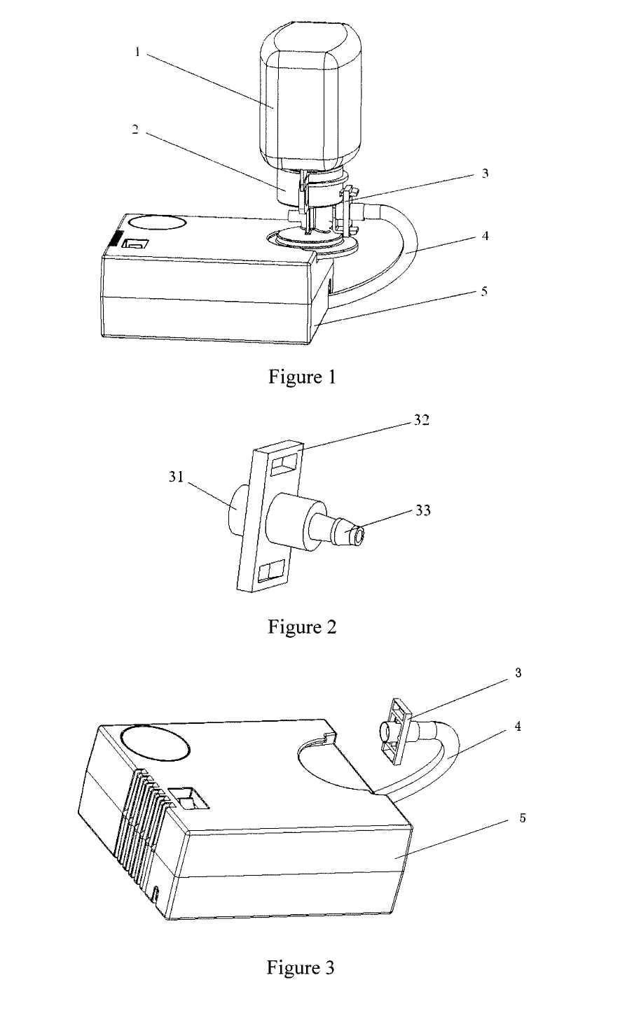

As shown in FIG. 1, in an embodiment for the air compressor of the present invention, the air compressor comprises a sealant bottle 1, a bottle cap 2, a quick connector 3, a flexible pipe 4 and a housing 5. The sealant bottle 1 is connected with the bottle cap 2, the flexible pipe 4 is connected with the bottle cap 2 through the quick connector 3 and the bottle cap 2 is fixed on the housing 5.

As shown in FIG. 2, it is a diagram illustrating the stereostructure of the quick connector 3. The quick connector 3 comprises a concave connecting member 31, a slot 32 and a convex connecting member 33. The slot 32 is located in the concave connecting member 31 and its both ends are provided with a slotted hole. The stereogram illustrating the connection between the quick connector 3 and the flexible pipe 4 is shown in FIG. 3, in which the convex connecting member 33 is inserted into the open end of the flexible pipe 4, and the convex connecting member 33 is installed with a sealing element to ensure the sealing performance and stability for the connection between the quick connector 3 and the flexible pipe 4. This connection type does not need to loosen a threaded connection, in which case it can avoid the danger of cross threading and can achieve a fast speed for connecting the quick connector 4 with the flexible pipe 4. Besides, a short flexible pipe is used as the flexible pipe 4, thereby reducing the assembly time and assembly cost.

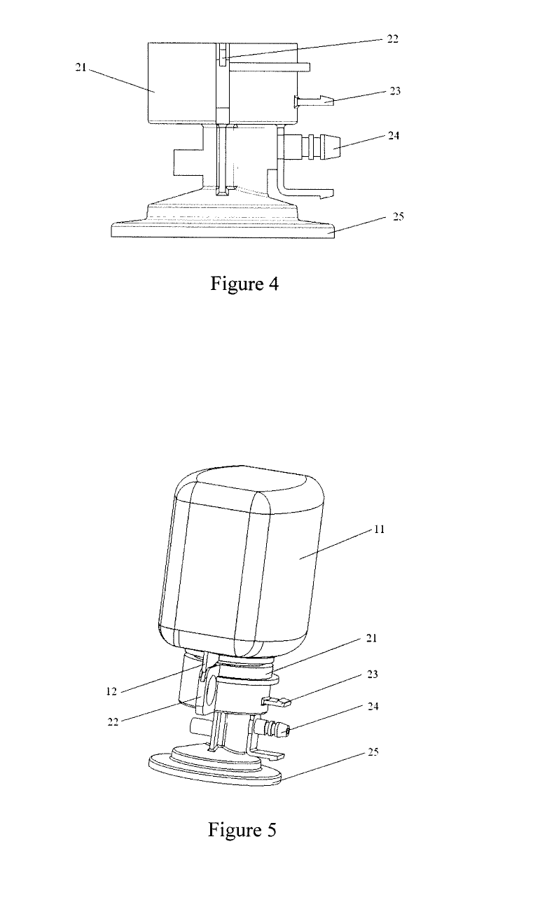

As shown in FIG. 4 and FIG. 5, the bottle cap 2 comprises a concave connecting section 21, a groove 22, a retaining pin 23, a convex connecting section 24 and a base 25. The convex connecting section 24 is inserted into the concave connecting member 31 in order to achieve the connection between the quick connector 3 and the bottle cap 2. Between the convex connecting section 24 and the concave connecting member 21 is installed with a sealing device to ensure the stability and sealing performance of the connection. The retaining pin 23 made of elastic material comprises a guide part and a lowering plat part, while its size is corresponded with that of the slot 32. The guide part with an arc chamfering is adopted, and this will facilitate to insert the retaining pin 23 into the slot 32. The lowering plat part is used to limit the movement of the slot 32. When the connection between the quick connector 3 and the bottle cap 2 is finished, the convex connecting section 24 has to be locked securely, and the connection should be stable and persistent. If there is no sufficient stability, the movement between the quick connector 3 and the bottle cap 2 will lead to excessive wear and premature failure inside the connection, especially the sealing elements. In the present invention, such cooperating connection is employed between the retaining pin 23 and the slot 32, which can lock the connection between the quick connector 3 and the bottle cap 2 so as to reduce the risk of excessive wear and premature failure inside the connection caused by the movement between the two. When the quick connector 3 is connected with the bottle cap 2, the retaining pin 23 is used to lock the connection between the two; when pressing the retaining pin 23, it is used to open the locking so as to disassemble the connection between the quick connector 3 and the bottle cap 2.

The sealant bottle 1 comprises a bottle body 11, a convex element 12 and a bottleneck. The bottleneck is connected with the concave connecting section 21, between which is installed with a sealing element to realize the stability and sealing performance of the connection between the sealant bottle 1 and the bottle cap 2. The convex element 12 cooperates with the groove 22 in order to limit the movement between the sealant bottle 1 and the bottle cap 2 and improve the stability of the connection between them.

The sealant bottle 1 is connected with the bottle cap 2 and is fixed on the housing 5 through the base 25 of the bottle cap 2. When using the quick connector 3 in the concrete, firstly the convex connecting member 33 of the quick connector 3 is inserted into the open end of the flexible pipe 4, and then the concave connecting member 31 of the quick connector 3 is inserted into the convex connecting section 24 of the bottle cap 2. Meanwhile, the slotted hole of the slot 32 is inserted into the retaining pin 23, so as to lock the connection between the flexible pipe 4 and the sealant bottle 1. The connecting structure between the flexible pipe 4 and the sealant bottle 1 of the air compressor is simple in structure, convenient in operation and low in cost.

While the embodiments of the present invention are described with reference to the accompanying drawings above, the present invention is not limited to the above-mentioned specific implementations. In fact, the above-mentioned specific implementations are intended to be exemplary not to be limiting. In the inspiration of the present invention, those ordinary skills in the art can also make many modifications without breaking away from the subject of the present invention and the scope of protection of the claims. All these modifications belong to the protection of the present invention.

1. An air compressor, comprising a sealant bottle (1), a bottle cap (2) connected with the sealant bottle (1), a flexible pipe (4) and a housing (5), wherein, the flexible pipe (4) is connected with the bottle cap (2) through a quick connector (3), and the bottle cap (2) is fixed on the housing (5).

2. The air compressor according to claim 1, wherein the bottle cap (2) comprises a concave connecting section (21) connected with the sealant bottle (1), a convex connecting section (24) connected with the quick connector (3), a groove (22), a retaining pin (23) and a base (25); the retaining pin (23) comprises a guide part and a lowering plat part.

3. The air compressor according to claim 2, wherein the quick connector (3) comprises a concave connecting member (31), a slot (32) located in the concave connecting member (31) and a convex connecting member (33); the slot (32) comprises a slotted hole connected with the guide part correspondingly; through the connection with the retaining pin (23), the connection between the quick connector (3) and the bottle cap (2) is ensured to be locking.
